(19) United States
(12) Patent Application Publication
(10) Pub. No.: US 2012/0276456 A1
(43) Pub. Date: Nov. 1, 2012

(54) ADDITIVE FOR ELECTROLYTES IN ELECTROCHEMICAL CELLS

(75) Inventors: Peter Pilgram, Dresden (DE); Rolf-Walter Terwonne, Marl (DE); Denny Thiemig, Dresden (DE); Joerg Kaiser, Eggenstein (DE); Andreas Gutsch, Luedinghausen (DE)

(73) Assignee: LI-TEC BATTERY GMBH, Kamenz (DE)

(21) Appl. No.: 13/393,203

(22) PCT Filed: Aug. 27, 2010
(86) PCT No.: PCT/EP2010/005290

§ 371 Date: Jul. 19, 2012

(30) Foreign Application Priority Data
Sep. 8, 2009 (DE) 10 2009 040 562.3

(51) Int. Cl. H01M 10/056; H01M 10/02

(52) U.S. Cl. 429/328; 429/188; 429/199; 429/338; 429/342; 429/337; 429/340; 429/336; 429/343; 429/331; 429/332; 429/326; 429/329; 429/330

(57) ABSTRACT

Electrolyte, comprising an aprotic solvent, a lithium salt as conducting salt, and an additive, characterized in that the additive is a compound which contains a protonable nitrogen atom and is hydrolysable by water.

Priority application DE 10 2009 040 562.3 as filed on Sep. 8, 2009 is fully incorporated herein by reference.

The invention relates to an electrolyte for electrochemical cells, wherein the electrolyte has a reduced water content and acid content, to an electrochemical cell comprising said electrolyte and to the use of additives by means of which said reduced water content and acid content is achieved.

The fields of application of lithium ion batteries, in particular of rechargeable lithium ion batteries and lithium ion accumulators, range from high quality electronic devices such as mobile phones and camcorders to motor vehicles having an electric drive or a hybrid drive.

Such batteries or accumulators, in the following generally referred to as electrochemical cells, comprise cathode, anode, separator, and a non-aqueous electrolyte. Typically, lithium manganate, lithium cobaltate, and lithium nickelate, also in form of the mixed oxides, or other lithium intercalation compounds and lithium insertion compounds, are used as cathode. As anode, lithium metal, various carbon types, graphite, graphitic carbon as well as lithium intercalation compounds and insertion compounds such as lithium titanate or alloys may be used. As an electrolyte, solutions of inorganic and organic lithium salts, i.e. conducting salts (“Leitsalze”), in aprotic solvents are used. Suitable conducting salts are, for example, LiPF₆, LiBF₄, LiClO₄, LiAsF₆, LiCF₃SO₃, LiN(CF₃SO₂)₂, or LiC(CF₃SO₂)₃, and mixtures thereof. Aprotic solvents typically are ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanones, sulfolanes, dimethylsulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, ethyl acetate, and mixtures thereof.

Due to the sensitivity with respect to hydrolysis against water and other protic impurities of the conducting salts which are used in lithium ion batteries and which frequently are fluoride-containing conducting salts, said electrolytes have a measurable amount of acid such as hydrofluoric acid. Frequently, the electrolyte contains an additional hydrofluoric acid amount of approximately 50 ppm or more due to the manufacturing process. Apart from this acid may also be formed by means of a thermal stress exerted onto the system.

Materials for separators, electrodes, and electrolytes as they are nowadays used in lithium ion cells, react very sensitively already with regard to traces of water within the range of some 10 ppm and show an accelerated ageing. Thus, the hydrofluoric acid produced may react with different components of the electrochemical cell, wherein corrosion may occur or even explosive gases may be formed under the electrochemical conditions. Thereby, the dissolving of metals out of the active materials of the electrodes may occur, or, respectively, an undesired pressure increase in the cell may occur. Such reactions are not desired in electrochemical cells since they negatively affect the properties thereof.

Furthermore, the cover layer which is located on the electrodes may also be negatively affected. For example, typically, cover layers made from alkyl carbonates, lithium carbonates, lithium hydroxides, and lithium oxides are present on graphite electrodes, wherein hydrofluoric acid may react with said cover layer. Thereby, the carbonate cover layer may be degraded and a lithium fluoride film may be formed. Contrary to the original cover layer, such layer is not or only poorly permeable for lithium ions. Due to this, the impedance of the electrochemical cell is increased in an undesired manner.

From DE 100 27 626 A1, it is known to scavenge produced hydrofluoric acid by means of the addition of additives, and thereby to prevent the formation of the LiF film. For example, tributylamine may be used as acid scavenger. However, it is also possible to employ specific silanes which prevent the formation of a LiF film by means of the solubility properties thereof in respect to lithium fluoride.

The present invention is based on the problem to provide additives which further reduce the water content in electrolytes for electrochemical cells, and thereby counteract the formation of acid, respectively scavenge the already existing acid, thus, improve the properties of the cell.

It has been discovered that compounds which contain a protonable nitrogen atom, i.e., a function as a base, and which are hydrolysable, solve the posed problem. By means of the hydrolysis reaction, a water content present in the electrolyte is reduced. The base functions as an acid scavenger. Accordingly, when using such a compound in an electrolyte for an electrochemical cell, the formation of acid, in particular of hydrofluoric acid, may be minimized and the formation of a LiF film on the electrodes of the electrochemical cell may be largely suppressed. With this, the impedance of the cell may be stabilized.

A first aspect of the invention thus relates to an electrolyte comprising an aprotic solvent, a lithium salt as a conducting salt and an additive, characterized in that the additive comprises a compound which contains a protonable nitrogen atom, and which is hydrolysed by means of water.

Preferably, the additive is employed in an electrolyte which comprises a lithium-containing inorganic conducting salt or a lithium-containing organic conducting salt which is dissolved in an aprotic solvent.

Preferably, the additive is present in dissolved form in the electrolyte, which commonly is employed in electrochemical cells, preferably in rechargeable lithium ion batteries.

Preferably, the aprotic solvent which is present in the electrolyte is a solvent as described above with respect to the state of the art, thus, preferably, selected from the group consisting of ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanones, sulfolanes, dimethylsulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, ethyl acetate, and mixtures of two or more of these aprotic solvents.

The compounds used as conducting salts are preferably the inorganic and organic lithium compounds as described above in the state of art, thus, preferably, selected from the group consisting of LiPF₆, LiBF₄, LiCIO₄, LiAsF₆, LiCF₃SO₃, LiN(CF₃SO₂)₂, or LiC(CF₃SO₂)₃, as well as LiSO₃CₓF₂ₓ₊₁, LiN(SO₂CₓF₂ₓ₊₁)₂ or LiC(SO₂CₓF₂ₓ₊₁)₃ with 0≦x≦8, and mixtures of two or more of these conducting salts.

According to the invention, in the additive, or as the additive, all compounds may be employed having a protonable nitrogen atom, and which may be hydrolysed by water or which at least may be partially hydrolysed. Under the operating conditions of the cell, said compound, respectively the resulting compound which is formed by hydrolysis and, as the case may be, by protonation, or other subsequently formed compounds, should have a sufficiently high electrochemical stability, i.e., such compound should not be decomposed by the electrochemical reaction.

The protonable nitrogen atom may be part of a primary, a secondary, or a tertiary amino group.

In a preferred embodiment, the compound which contains a protonable nitrogen atom and which is hydrolysed by water, is a silicon (Si) compound.

Preferably, the silicon compound contains a silicon-oxygen bond which is cleaved under the influence of water, i.e. is hydrolysed. It is known that, for example, corresponding alkoxy compounds may be easily hydrolytically cleaved by means of water.

Particularly preferred is also a silicon compound which contains a hydrolysable silicon-oxygen bond, wherein the protonable nitrogen atom is part of a primary, a secondary or a tertiary amino group.

In a preferred embodiment, the silicon compound comprises the structural element R₁—Si—OR₂, wherein R₁ is an alkyl residue of from 1 to 12 carbon atoms, preferably of from 1 to 6 carbon atoms, wherein the alkyl residue is substituted with an amino group. R₂ is an alkyl residue of from 1 to 12 carbon atoms, preferably of from 1 to 6 carbon atoms, or an aromatic residue (aryl residue). An aromatic residue preferably is a phenyl residue.

In a further preferred embodiment, the silicon compound is of the formula R₁—Si(—OR₂)(—R₃)(—R₄), wherein R₁ and R₂ have the meaning as defined above. R₃ and R₄ are, independently from each other, alkyl residues of from 1 to 12 carbon atoms, preferably of from 1 to 6 carbon atoms, or alkoxy residues of from 1 to 12 carbon atoms, preferably of from 1 to 6 carbon atoms, or aromatic residues, preferably phenyl residues, or aryloxy residues, preferably phenoxy residues.

Preferably, the silicon compound is an (aminoalkyl) trialkoxysilane.

Preferably, the silicon compound is of the formula R₁—Si(—OR₂)(—OR₅)(—OR₆), wherein R₁ has the meaning as defined above, and R₂, R₅ and R₆ are independently from each other alkyl residues of from 1 to 12 carbon atoms, preferably of from 1 to 6 carbon atoms.

Preferably, suitable compounds are (2-aminoethyl) trimethoxysilane, (2-aminoethyl) triethoxysilane, a (2-aminoethyl) tripropoxysilane, a (2-aminoethyl) tributoxysilane, (3-aminopropyl) trimethoxysilane, (3-aminopropyl) triethoxysilane, (3-aminopropyl) tripropoxysilane, (3-aminopropyl) tributoxy silane.

In a particularly preferred embodiment, the silicon compound is (3-aminopropyl) triethoxysilane or (3-aminopropyl) trimethoxysilane.

Particularly preferred as silicon compound is (3-aminopropyl) triethoxysilane (CAS-No. 919-30-2).

The aminosilanes as mentioned may also be used in a form, in which the primary amino group is further alkylated, i.e., in the form of a secondary or tertiary amino group.

The above silicon compounds are known and/or may be produced according to known methods.

The compounds may be added as an additive to an electrolyte which is used in an electrochemical cell in a concentration of from 0.01 to 10 wt.-% based on all substances which are contained in the electrolyte. Preferably, the additive is present in a concentration of from 0.1 to 5 wt.-%.

The aminosilane compound which is used as an additive or in the additive is characterized by a favorable electrochemical stability. It has been discovered that the stability against oxidation generally is sufficiently high for the use in electrochemical cells, preferably in lithium ion batteries.

A second aspect of the invention relates to an electrochemical cell comprising a cathode, an anode, a separator, and an electrolyte, characterized in that the electrolyte is an electrolyte according to the invention, i.e., an electrolyte which comprises, as an additive, a compound comprising a protonable nitrogen atom and which is hydrolysed by water.

A third aspect of the invention relates to the use of a compound which contains a protonable nitrogen atom and which is hydrolysed by water, as an additive or in an additive for an electrolyte of an electrochemical cell.

Preferably, the compound is used for the binding of water and acid.

1-15. (canceled)

16. A method comprising:
using a silicon compound, which contains a protonable nitrogen compound, and which is hydrolyzed by water, to bind water and acid in an electrochemical cell comprising a cathode, an anode, a separator, and an electrolyte, wherein said electrolyte comprises an aprotic solvent, and a lithium salt as conducting salt.

17. The method according to claim 16, wherein said silicon compound comprises the structural element R₁—Si—OR₂, wherein R₁ is an alkyl residue of from 1 to 12 carbon atoms, which is substituted with an amino group, and R₂ is an alkyl residue of from 1 to 12 carbon atoms, or an aromatic residue.

18. The method according to claim 16, wherein said silicon compound is of the formula R₁—Si(—OR₂)(—R₃)(—R₄), wherein R₁ is an alkyl residue of from 1 to 12 carbon atoms, which is substituted with an amino group, R₂ is an alkyl residue of from 1 to 12 carbon atoms, or an aromatic residue, and R₃ and R₄ are independently from each other alkyl residues of from 1 to 12 carbon atoms, or alkoxy residues of from 1 to 12 carbon atoms, or aromatic residues, or aryloxy residues.

19. The method according to claim 16, wherein said silicon compound is an (aminoalkyl) trialkoxysilane.

20. The method according to claim 19, wherein said R₂ is an alkyl residue of from 1 to 12 carbon atoms, and R₃ and R₄ are alkoxy residues of from 1 to 12 carbon atoms.

21. The method according to claim 16, wherein said silicon compound is selected from the group consisting of (2-aminoethyl) trimethoxysilane, (2-aminoethyl) triethoxysilane, (2-aminoethyl) tripropoxysilane, (2-aminoethyl) tributoxysilane, (3-aminopropyl) trimethoxysilane, (3-aminopropyl) triethoxysilane, (3-aminopropyl) tripropoxysilane, and (3-aminopropyl) tributoxysilane.

22. The method according to claim 16, wherein said silicon compound is (3-aminopropyl) triethoxysilane or (3-aminopropyl) trimethoxysilane.

23. The method according to claim 16, wherein said protonable nitrogen compound is part of a primary, a secondary or a tertiary amino group.

24. The method according to claim 16, wherein said compound is contained in the electrolyte in a concentration of from 0.01 to 10 wt.-%.

25. The method according to claim 24, wherein said compound is contained in the electrolyte in a concentration of from 0.1 to 5 wt.-%.

26. The method according to claim 16, wherein said conducting salt is selected from the group consisting of LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₊₁)₂, and LiC(SO₂CₓF₂ₓ₊₁)₃, wherein 0≦x≦8.

27. The method according to claim 16, wherein said conducting salt comprises s mixture of two or more of LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₊₁)₂, and LiC(SO₂CₓF₂ₓ₊₁)₃, wherein 0≦x≦8.

28. The method according to claim 16, wherein said solvent is selected from the group consisting of ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanones, sulfolanes, dimethylsulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, and ethyl acetate.

29. The method according to claim 16, wherein said solvent comprises a mixture of two or more of ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanones, sulfolanes, dimethylsulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, ethyl acetate.

30. The method according to claim 16, wherein said acid is hydrofluoric acid.
